(19) United States
(12) Patent Application Publication
(10) Pub. No.: US 2009/0158372 A1
(43) Pub. Date: Jun. 18, 2009

(54) METHOD AND APPARATUS FOR PROVIDING BROADCAST SERVICE INFORMATION IN CABLE NETWORK

(76) Inventors: Woongshik YOU, Chungcheongnam-Do (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/256,545

(22) Filed: Oct. 23, 2008

(30) Foreign Application Priority Data
Dec. 17, 2007 (KR) 10-2007-0132561
Jan. 29, 2008 (KR) 10-2008-0009051

(51) Int. Cl. H04N 7/173

(52) U.S. Cl. 725/110

(57) ABSTRACT

Disclosed are a method and apparatus for providing broadcast service information in a cable network. A data transmitting method of the broadcast service information providing apparatus includes receiving IPTV broadcast contents, configuring broadcast service information on the IPTV broadcast contents, assigning a virtual channel to the broadcast service information; and transmitting, to a terminal, the broadcast service information to which the virtual channel is assigned. A data receiving method of a terminal includes receiving broadcast service information to which a virtual channel is assigned, displaying configuration information of the virtual channel, selecting the virtual channel, and decoding the broadcast service information assigned to the selected virtual channel to display the decoded information.

### CROSS-REFERENCE TO RELATED APPLICATION

This application claims the benefit of Korean Patent Application Nos. 10-2007-0132561, filed on Dec. 17, 2007, and 10-2008-0009051, filed on Jan. 29, 2008, in the Korean Intellectual Property Office, the entire disclosures of which are incorporated herein by reference.

### BACKGROUND OF THE INVENTION

1. Field of the Invention

The present invention relates to a method and apparatus for providing broadcast service information in a cable network, and more particularly, to a method and apparatus for providing broadcast service information in a cable network which may provide various broadcast service information.

This work was supported by the IT R&D program of MIC/IITA. [2006-S-019-02, The Development of Digital Cable Transmission and Receive System for 1 Gbps Downstream]

2. Description of Related Art

In current broadcast services, all channels over the air are provided to terminal equipments such as a set-top box and the like regardless of whether a specific channel is viewed.

Conversely, in Internet Protocol Television (IPTV) services, a viewer selects corresponding broadcast contents, and then the corresponding broadcast contents can be eventually provided to the terminal equipment. Accordingly, service information about IPTV broadcast contents is required to be provided to the terminal equipment, so that the viewer can select the broadcast contents. Current IPTV may use an Electronic Program Guide (EPG) and the like in order to transmit information about the broadcast contents being currently served to the viewer.

The viewer may select the broadcast contents through an interface such as a remote control and the like using the EPG. In this instance, the EPG may provide only a relatively small quantity of information displaying the corresponding contents on a small screen. As a result, it may be difficult for the viewer to acquire a variety of information, resulting in creating inconvenience in selecting the IPTV broadcast contents.

### SUMMARY OF THE INVENTION

An aspect of the present invention provides a method and apparatus for providing broadcast service information which may receive a variety of broadcast service information using a virtual channel, thereby readily selecting broadcast contents.

According to an aspect of the present invention, there is provided an apparatus for providing broadcast service information, the apparatus including: a broadcast service information providing unit to provide service information on Internet Protocol Television (IPTV) broadcast contents; and a broadcast service information transmitting unit to assign a virtual channel to the broadcast service information, and transmit the broadcast service information to which the virtual channel is assigned.

According to an aspect of the present invention, there is provided a terminal including: a cable modem to receive broadcast service information to which a virtual channel is assigned; and a set-top box to display configuration information of the virtual channel, decode the broadcast service information assigned to a selected virtual channel when the virtual channel is selected, and display the decoded information.

According to an aspect of the present invention, there is provided a data transmitting method of a broadcast service information providing apparatus, the data transmitting method including: receiving IPTV broadcast contents; configuring broadcast service information on the IPTV broadcast contents; assigning a virtual channel to the broadcast service information; and transmitting, to a terminal, the broadcast service information to which the virtual channel is assigned.

According to an aspect of the present invention, there is provided a data receiving method of a terminal, the data receiving method including: receiving broadcast service information to which a virtual channel is assigned; displaying configuration information of the virtual channel; selecting the virtual channel; and decoding the broadcast service information assigned to the selected virtual channel to display the decoded information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a schematic diagram illustrating a configuration of a system for providing Internet Protocol Television (IPTV) broadcast services using a cable network;

FIG. 2 is a diagram illustrating an example of a configuration of IPTV broadcast service information;

FIG. 3 is a flowchart illustrating an operation process of a cable headend system according to an exemplary embodiment of the invention; and

FIG. 4 is a flowchart illustrating an operation process of a terminal equipment according to an exemplary embodiment of the invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

According to a basic principle of the present invention, a user may readily select desired Internet Protocol Television (IPTV) broadcast contents using various IPTV service information by transmitting/receiving the IPTV service information to which a virtual channel is assigned.

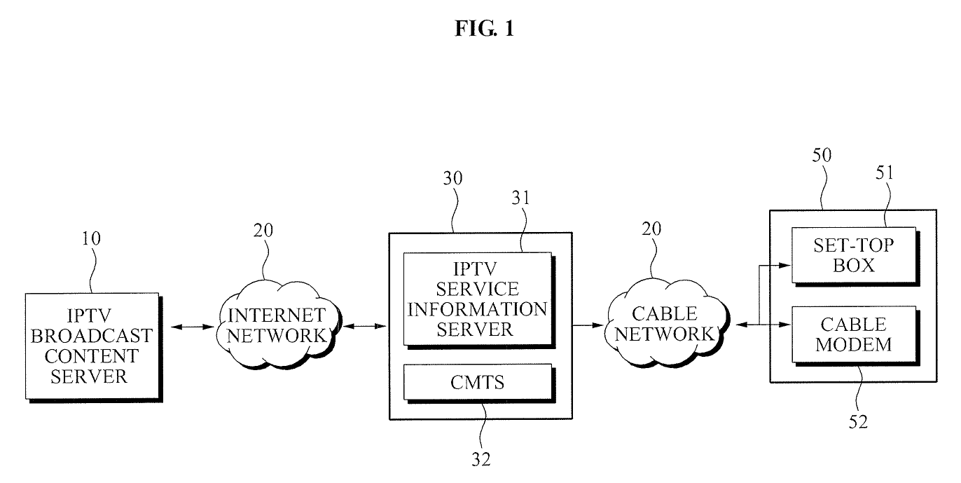

FIG. 1 is a schematic diagram illustrating a configuration of a system for providing Internet Protocol Television (IPTV) broadcast services using a cable network.

Referring to FIG. 1, the system for providing IPTV broadcast services using the cable network includes an IPTV broadcast content server 10, a cable headend system 30, and a terminal equipment 50.

The IPTV broadcast content server 10 provides IPTV broadcast contents.

The cable headend system 30 is connected with the IPTV broadcast content server 10 and an Internet network 20, and includes an IPTV service information server 31 and a Cable Modem Termination System 32 (CMTS).

The IPTV service information server 31 constitutes service information on IPTV broadcast contents provided to the terminal equipment 50. In this instance, the service information for the IPTV broadcast contents constitutes image information having an image size smaller than an original image size of provided contents. For example, The IPTV service information server 31 constitutes service information composed of image information having reduced resolution of 320*240 and audio and supplementary information using contents having 1920*1080 resolution.

The CMTS 32 transmits the IPTV broadcast contents and the IPTV service information to the terminal equipment 50.

Specifically, the CMTS 32 receives the IPTV service information from the IPTV service information server 31, and assigns different virtual channels for each of the IPTV broadcast contents to the IPTV service information. Here, the virtual channel is a channel virtually assigned to the IPTV service information, and denotes an identifier assigned for the purpose of dividing each of the IPTV service information. Also, the virtual channel is not limited thereto, and may be used as an identifier for identifying each of the IPTV broadcast contents.

The virtual channel will be herein described in detail by comparing current broadcast services and the IPTV broadcast services.

In current broadcast services, KBS1, MBC, and SBS are respectively designated as a fixed channel number such as channel 7, channel 11, and channel 6, and a user selects and changes a channel using the fixed channel number. Conversely, in the IPTV broadcast services, the IPTV broadcast contents and the corresponding service information do not have a fixed, assigned-channel number, and select broadcast contents through a user interface using graphics.

However, in the IPTV broadcast services according to the present invention, a virtual channel is assigned to different service information for each of the IPTV broadcast contents, and thus enables separation of the IPTV service information. As a result, the user may select and change the IPTV service information using the virtual channel, which leads to easy selection of the IPTV broadcast contents.

The CMTS 32 transmits, to the terminal equipment 50 subscribed to the IPTV services, the IPTV service information to which the virtual channel is assigned using a communication channel having guaranteed channel quality.

The terminal equipment 50 is connected with the cable headend system 30 and the cable network 40. The terminal equipment 50 includes a cable modem 52 providing bidirectional communication services and a set-top box 51 decoding and outputting the IPTV broadcast contents.

The cable modem 52 receives, from the CMTS 32, the IPTV service information to which the virtual channel is assigned. Then, the cable modem 52 forwards the IPTV service information to which the virtual channel is assigned to the set-top box 51.

The set-top box 51 displays configuration information of the virtual channel. The configuration information of the virtual channel is a part of the IPTV service information, and for example, may include simple text information such as a virtual channel number selected by the user, an IPTV broadcast content title assigned to each of the virtual channels, and the like. Also, when the virtual channel is selected by the user, the set-top box 51 decodes IPTV service information corresponding to the selected virtual channel and displays the decoded information. Then, when the user selects the IPTV broadcast contents using the IPTV service information to which the virtual channel is assigned, the terminal equipment 50 may receive the corresponding IPTV broadcast contents from the IPTV broadcast content server 10.

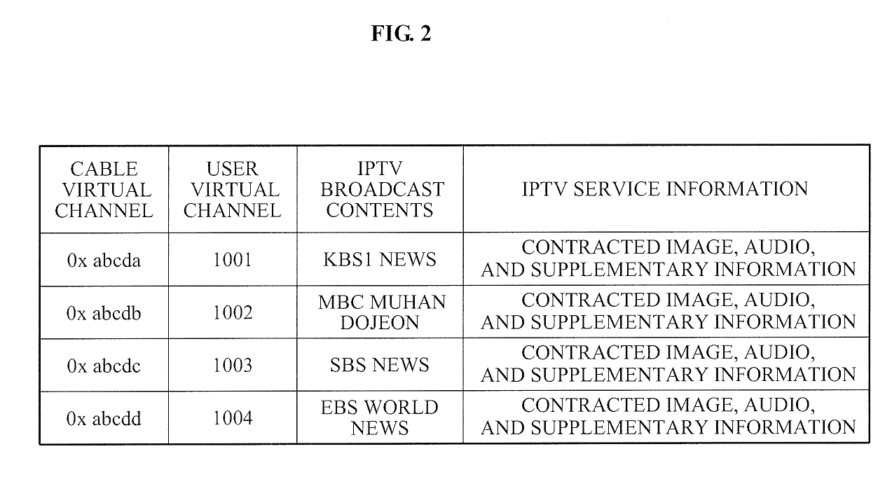

FIG. 2 is a diagram illustrating an example of a configuration of IPTV broadcast service information.

Referring to FIG. 2, the IPTV broadcast service information may include a virtual channel on a cable, a user virtual channel, a reduced image with respect to IPTV broadcast content title and contents, audio and supplementary information, and the like.

Here, the virtual channel on the cable is a virtual channel capable of being divided for the purpose of data transmission on a single physical transmission channel. For example, a single transmission channel having a transmission speed of 40 Mbps may be virtually divided into 40 virtual channels each having a transmission speed of 1 Mbps and used. The virtual channel on the cable is not a channel corresponding one-to-one to different IPTV service information for each of the IPTV broadcast contents.

However, according to the present exemplary embodiment of the invention, service information on a single IPTV broadcast content is assigned to each of the virtual channels on the cable, and thereby the service information on IPTV broadcast contents is provided. This is for the purpose of respectively controlling a transmit bandwidth required for each of IPTV service information transmission, and providing better quality services in comparison with general data.

The user virtual channel is an identifier assigned to divide, by the CMTS, the IPTV service information for each of the IPTV broadcast contents, and denotes channel information capable of being selected using a remote control and the like by the user.

Accordingly, the user may divide the IPTV service information for each of the IPTV broadcast contents using the user virtual channel, and select IPTV service information desired to be received.

Here, according to the comparison between the virtual channel on the cable and the user virtual channel, the virtual channel on the cable may sub-divide a physical transmission channel in a view of data transmission, and the user virtual channel may act as an identifier for dividing the IPTV service information or the IPTV broadcast contents mapped on each of the IPTV service information.

The IPTV broadcast content title denotes title information on contents assigned to the user virtual channel.

A process in which a user receives IPTV service information using the user virtual channel will be herein described in detail.

For example, service information on KBS 1 news contents is assigned to a user virtual channel 1001, and service information on SBS news contents is assigned to a user virtual channel 1003. Here, when the user selects the user virtual channel 1001, the terminal equipment may receive IPTV service information assigned to a virtual channel on a cable of Oxabcda, that is, moving image and supplementary information with respect to the KBS 1 news contents, and display the received information. Also, the user may select the user virtual channel 1003 when desiring to display moving image and supplementary information with respect to the SBS news contents, and thus readily receiving and displaying the corresponding IPTV service information.

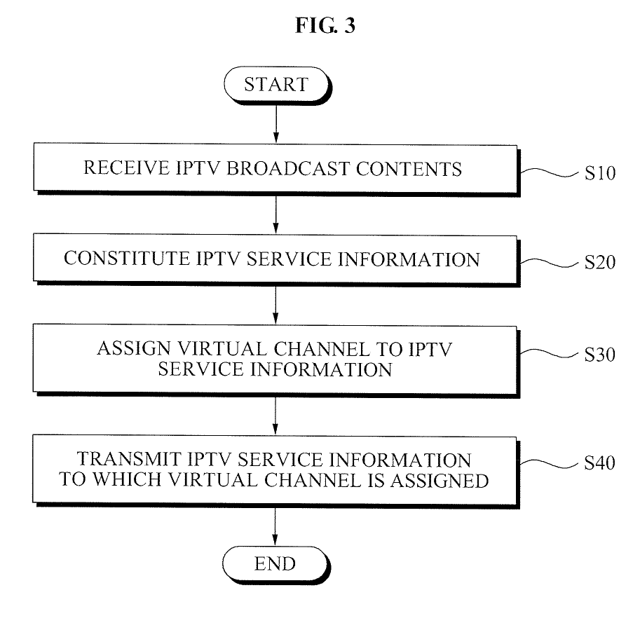

FIG. 3 is a flowchart illustrating an operation process of a cable headend system according to an exemplary embodiment of the invention.

Referring to FIG. 3, in operation S10, the cable headend system receives IPTV broadcast contents from the IPTV broadcast content server.

Next, in operation S20, the cable headend system constitutes IPTV service information.

The IPTV service information server constitutes the IPTV service information obtained by summarizing reduced image, audio, and supplementary information for the IPTV broadcast contents.

The CMTS receives the IPTV service information from the IPTV service information server, and assigns a virtual channel to the IPTV service information. In this instance, virtual channels different for each of IPTV service information are assigned to each of the IPTV broadcast contents.

Also, the CMTS may provide relative location information of each of the IPTV service information using virtual channel information. For example, a relative location of MBC Muhan-dojeon with respect to service information of the KBS 1 news assigned to the virtual channel 1001 may be the virtual channel 1002.

Next, in operation S40, the cable headend system transmits, to the terminal equipment, the IPTV service information assigned to the virtual channels through a communication channel having guaranteed channel quality.

In this instance, the cable headend system may also transmit the relative location information of each of the IPTV service information.

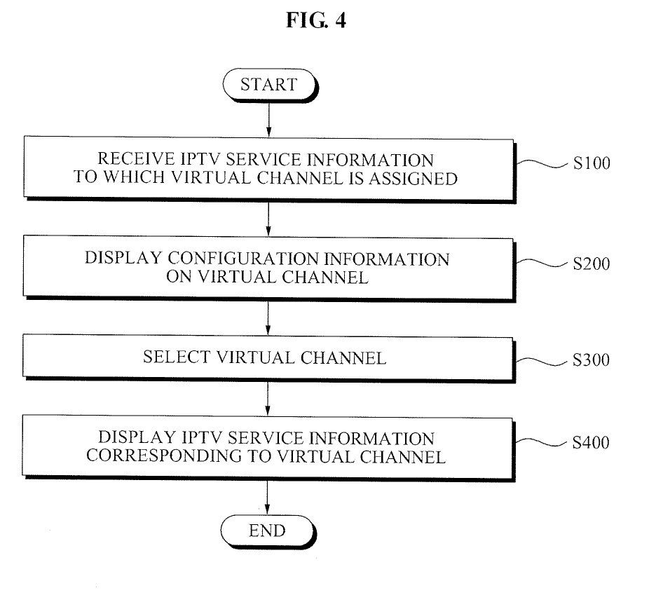

FIG. 4 is a flowchart illustrating an operation process of a terminal equipment according to an exemplary embodiment of the invention.

Referring to FIG. 4, in operation S100, the terminal equipment receives IPTV service information assigned to the virtual channels.

First, the cable modem receives the IPTV service information in which the virtual channel is assigned for each of the IPTV broadcast contents through the communication channel having guaranteed channel quality. The cable modem transmits the received IPTV service information to the set-top box.

Here, the set-top box may receive relative location information of the IPTV service information as well as each of the IPTV service information.

Next, in operation S200, the terminal equipment displays configuration information of the virtual channel.

The set-top box displays partial data such as the configuration information of the virtual channel. The configuration information of the virtual channel may include simple text information, for example, a user virtual channel, a title of the IPTV broadcast contents, and the like.

Next, in operation S300, the terminal equipment selects a virtual channel.

Specifically, the terminal equipment selects the virtual channel assigned to the IPTV service information with respect to IPTV broadcast contents desired to be received.

Next, in operation S400, the terminal equipment displays the IPTV service information.

The set-top box decodes the IPTV service information of the selected virtual channel, and displays the decoded information. Here, the IPTV service information includes moving image and supplementary information with respect to the IPTV broadcast contents. Next, when the user selects the IPTV broadcast contents using the IPTV service information to be displayed, the set-top box receives the IPTV broadcast contents corresponding to the displayed IPTV service information, and decodes the received IPTV broadcast contents.

However, the user may select another virtual channel when desiring to receive IPTV service information with respect to another IPTV broadcast contents. In this instance, the user may select the virtual channel using a user interface, that is, a remote control and the like.

A method for selecting the virtual channel through the user interface may vary.

As the example, a method for inputting the virtual channel and a method for successively changing the virtual channel may be given.

The method for inputting the virtual channel is a method of selecting the virtual channel by directly inputting a virtual channel number using numerical buttons of the remote control.

The method for successively changing the virtual channel is a method selecting the virtual channel using up/down buttons of the remote control. In this instance, the virtual channel maybe selected by utilizing relative location information of each of the IPTV service information.

Also, channels capable of being selected using the up/down buttons according to a user's preference are restrictively set, thereby maximizing effects of a function for successively changing the channel.

A method for selecting the virtual channel with respect to service information desired to be received will be herein described in detail with reference to FIG. 2.

For example, when the user desires to receive the service information with respect to the MBC Muhan-dojeon assigned to the virtual channel 1002 while receiving the service information with respect to the KBS 1 news assigned to the virtual channel 1001, the user may receive the service information with respect to the MBC Muhan-dojeon by selecting the virtual channel 1002.

Here, as for the method for selecting the virtual channel, the user may select the desired virtual channel number, that is, 1002 by directly inputting the virtual channel number using the numerical buttons of the remote control.

Also, the user may select a desired virtual channel number, that is, 1002 by inputting the up button of up/down buttons of the remote control to utilize the relative location information. Here, the relative location information with respect to the service information assigned to the virtual channel 1001 is assumed to be set as the virtual channel 1002.

As described above, according to the present invention, desired service information may be received using the virtual channel. Also, the service information for each of the broadcast contents may be facilitated to be retrieved by changing the virtual channel. Here, a time required for displaying the service information may be significantly reduced, and the service information may be rapidly provided to the user. Thus, the method and apparatus for providing IPTV service information according to the present invention may provide a variety of service information to the user, and enable the user to readily select broadcast contents, thereby more conveniently providing the broadcast services.

As described above, according to the present invention, there are provided the method and apparatus for providing broadcast service information which may provide the broadcast service information to which the virtual channel is assigned to thereby receive various IPTV service information using the virtual channel, and thus readily selecting the broadcast contents. As a result, inconvenience such as the service delay causing frequent changing of channels due to failure in receiving various broadcast service information may be reduced.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for providing broadcast service information, the apparatus comprising:
a broadcast service information providing unit to provide service information on Internet Protocol Television (IPTV) broadcast contents; and
a broadcast service information transmitting unit to assign a virtual channel to the broadcast service information, and transmit the broadcast service information to which the virtual channel is assigned.

2. The apparatus of claim 1, wherein virtual channels being different for each of the IPTV broadcast contents are assigned to the broadcast service information.

3. The apparatus of claim 1, wherein the broadcast service information is comprised of at least one of image information, audio information, and supplementary information, each being obtained by reducing the IPTV broadcast contents.

4. A terminal comprising:
a cable modem to receive broadcast service information to which a virtual channel is assigned; and
a set-top box to display configuration information of the virtual channel, decode the broadcast service information assigned to a selected virtual channel when the virtual channel is selected, and display the decoded information.

5. The terminal of claim 4, wherein the virtual channel is an identifier for identifying the broadcast service information.

6. The terminal of claim 4, wherein the broadcast service information is comprised of at least one of image information, audio information, and supplementary information, each being obtained by reducing the IPTV broadcast contents.

7. A data transmitting method of a broadcast service information providing apparatus, the data transmitting method comprising:
receiving IPTV broadcast contents;
configuring broadcast service information on the IPTV broadcast contents;
assigning a virtual channel to the broadcast service information; and
transmitting, to a terminal, the broadcast service information to which the virtual channel is assigned.

8. The data transmitting method of claim 7, wherein the virtual channel is an identifier for identifying the IPTV broadcast contents and the broadcast service information.

9. The data transmitting method of claim 7, wherein the broadcast service information is comprised of at least one of image information, audio information, and supplementary information, each being obtained by reducing the IPTV broadcast contents.

10. The data transmitting method of claim 7, further comprising:
configuring relative location information of the broadcast service information, and transmitting the relative location information to the terminal.

11. A data receiving method of a terminal, the data receiving method comprising:
receiving broadcast service information to which a virtual channel is assigned;
displaying configuration information of the virtual channel;
selecting the virtual channel; and
decoding the broadcast service information assigned to the selected virtual channel to display the decoded information.

12. The data receiving method of claim 11, wherein the configuration information of the virtual channel is text information including the virtual channel and a title of the IPTV broadcast contents corresponding to the virtual channel.

13. The data receiving method of claim 11, further comprising:
receiving IPTV broadcast contents corresponding to the displayed broadcast service information to decode the received IPTV broadcast contents.

14. The data receiving method of claim 11, wherein the virtual channel is selected using a user interface.

15. The data receiving method of claim 11, wherein the virtual channel is selected by inputting a virtual channel number.

16. The data receiving method of claim 11 further comprising:
receiving relative location information of the broadcast service information.

17. The data receiving method of claim 16, wherein the virtual channel is selected by successively changing a channel using the relative location information.
